(19) United States
(12) Patent Application Publication
(10) Pub. No.: US 2013/0223882 A1
(43) Pub. Date: Aug. 29, 2013

(54) OUTPUT OF A CORONA CHARGER

(71) Applicant: Mark C. Zaretsky, Rochester, NY (US)

(72) Inventor: Mark C. Zaretsky, Rochester, NY (US)

(21) Appl. No.: 13/408,098

(22) Filed: Feb. 29, 2012

(51) Int. Cl. G03G 21/00

(52) U.S. Cl. 399/129

(57) ABSTRACT

A method for charging a static dissipative object on an insulating surface with a constant current includes placing a corona electrode in close proximity to the static dissipative object; placing a shell electrode in close proximity to the corona electrode; connecting a high voltage power supply to the corona electrode; raising the potential of the shell electrode to at least one tenth the magnitude of the potential of the corona electrode; sensing a first current from the high voltage power supply to the corona electrode; sensing a second current from the shell electrode to ground; and adjusting a voltage on the high voltage power supply to maintain a constant difference between the first current and the second current.

### CROSS-REFERENCE TO RELATED APPLICATIONS

Reference is made to commonly-assigned copending U.S. patent application Ser. No. ______ (Attorney Docket No. K000870US01NAB), filed herewith, entitled IMPROVED OUTPUT OF A CORONA CHARGER, by Zaretsky; U.S. patent application Ser. No. ______ (Attorney Docket No. K000925US01NAB), filed herewith, entitled IMPROVED OUTPUT OF A CORONA CHARGER, by Zaretsky; and U.S. patent application Ser. No. ______ (Attorney Docket No. K000928US01NAB), filed herewith, entitled IMPROVED OUTPUT OF A CORONA CHARGER, by Zaretsky; the disclosures of which are incorporated herein.

### FIELD OF THE INVENTION

This invention pertains to the field of electrophotographic printing and more particularly to the charging, with a constant current, of a static dissipative object on a moving insulating web.

### BACKGROUND OF THE INVENTION

Electrophotography is a useful process for printing images on a receiver (or “imaging substrate”), such as a piece or sheet of paper or another planar medium, glass, fabric, metal, or other objects as will be described below. In this process, an electrostatic latent image is formed on a photoreceptor by uniformly charging the photoreceptor and then discharging selected areas of the uniform charge to yield an electrostatic charge pattern corresponding to the desired image (an “electrostatic latent image”).

After the electrostatic latent image is formed, charged toner particles are brought into the operative proximity of the photoreceptor and are attracted to the photoreceptor in such a manner as to convert or develop the electrostatic latent image into a visible image. It should be noted that the “visible image” includes images that may not be readily visible to the naked eye, depending on the composition of the toner particles (e.g. clear toner).

After the electrostatic latent image is developed into a visible image on the photoreceptor, the visible image is then electrostatically transferred to the receiver. There are at least two different variations on this process. In a direct transfer process (V1), the visible image is electrostatically transferred from the photoreceptor to the receiver by subjecting the toner image to an electrostatic field that urges the toner image from the photoreceptor to the receiver while pressing the receiver against the photoreceptor. This is often accomplished using an electrically biased transfer roller, although other methods are known in the art. A multicolor print is formed by repeating this direct transfer process multiple times. For example, a color print may be formed by combining separations corresponding to the subtractive primary colorants, cyan, magenta, yellow, and black, developed onto separate regions or frames on the photoreceptor. These separations are sequentially and in register transferred onto the receiver.

In an alternative version of a transfer process (V2), the toner image is first transferred from the photoreceptor to an intermediate transfer member, typically a static dissipative belt or roller, and then transferred from the intermediate transfer member to the receiver. A multicolor print can be printed in one of two methods using an intermediate transfer member. In the first method, the color separations are printed in separate frames on either the same photoreceptor or on separate photoreceptors. These color separations are then transferred, in register, to the intermediate transfer member. The registered images are then transferred to the receiver in a single pass. In the second method, each separation is first transferred to one or more intermediate transfer members, the separations remaining distinct while on the one or more intermediate transfer members. The separations are then transferred, in register, to the receiver. The separations can be transferred to individual areas or frames on the one or more intermediate transfer members and repeatedly transferring the separations, in register, to the receiver after all the separations had been transferred to the one or more intermediate transfer members. Alternatively, each separation can be transferred from an intermediate transfer member to the receiver prior to the transfer of a subsequent separation from the photoreceptor to the receiver.

The toner image is fixed to the receiver by subjecting the toner bearing receiver to a combination of heat and pressure to soften and flow the toner.

In some printers the receiver is transported into and out of operative proximity to the photoreceptor and intermediate transfer member using an electrostatic transport web whereby the receiver is electrostatically tacked onto the web. Electrostatic charge of a first polarity is deposited on the surface of the receiver using a non-contacting corona charger, and charge having a second polarity opposite the first polarity is deposited on the inside surface of the transport web (for example, an insulating polyethylene terephthalate (PET) web) using a second charging device such as a corona or roller charger or a passive discharger. The resulting electrostatic force of attraction affixes the receiver to the web, enabling the receiver to be transported through the printer while maintaining good control of the spatial location of the paper at any point in the printing process. Good control is critical for obtaining good color-to-color registration. An example of such a transport system for variation 2 (V2) of the transfer process is provided in U.S. Pat. No. 6,243,555.

A non-contact method of charging the receiver uses a corona charger containing a corona electrode to which a high DC voltage has been applied and a conductive metal shell mostly surrounding the corona electrode, leaving a portion of the corona electrode exposed to the receiver. The conductive metal shell is biased at or near 0 volts. The current to the receiver is defined as the difference between the measured current emitted by the corona electrode and the measured current to the conductive metal shell. The current to the receiver is used to adjust the corona electrode voltage so as to obtain a desired constant receiver current. Non-contact charging avoids the exchange of contaminants with the receiver surface, as might occur using contact charging such as done with a roller charger.

As the operating speed of the printer is increased, it is necessary to increase the receiver current so that the charge density on the surface of the receiver, also referred to as the surface charge density, is sufficient to establish an adequate force to affix the receiver to the transport member.

The tackdown force increases quadratically with the surface charge density deposited on the receiver. The receiver surface potential is given by the ratio of the surface charge density to the capacitance of the receiver surface. While the receiver and transport web are located under a corona charging device, simultaneous with a ground plane contacting the transport web on the side opposite the receiver, the receiver and transport web can be treated as simple capacitors (cᵣ and c_{tw}) connected in series. The receiver surface potential will vary inversely with the total capacitance c_{rtw}=[1/cᵣ+1/c_{tw}]⁻¹. As the receiver capacitance cᵣ decreases, the total capacitance c_{rtw} also decreases, therefore the receiver surface potential increases for a given level of deposited surface charge density. This increase in surface potential requires the corona charging device to operate at a higher corona electrode voltage in order to deposit the requisite amount of charge and therefore deliver the desired tackdown force. Higher operating voltages create difficulties in charger design so as to avoid arcing, resulting in larger charger geometries as well as increased power consumption. The receiver capacitance decreases with a number of factors including: 1) increasing thickness, 2) decreasing dielectric constant, and 3) increasing resistivity. So it becomes more difficult to deposit sufficient charge on a thicker receiver using a small charger having low power consumption.

A system for operating a corona charging device in a constant charging current mode is described in U.S. Pat. No. 5,079,669. The purpose of this device is to charge the surface of a photoreceptor to a uniform level and reduce sensitivity of the charging process to variations created by temperature, humidity, wear, and spacing between the charging device and the photoreceptor. In this invention the current flowing through the shell is summed with the current flowing to the photoconductor using a current summing node and employs a resistor to do so, as shown in FIG. 1. The voltage on shell 34 is determined by the product of Iₚ (photoconductor current) and resistor 84 and is of a low voltage on the order of 5V given Iₚ values on the order of 50 μA and resistor values on the order of 100 kΩ. This shell voltage is about 1000× lower than the wire voltage of 5 kV. Furthermore, the shell voltage is also the negative input to operational amplifier 64 and as such would typically be in the range of 0V to 5V.

Additionally, the photoreceptor is charged to a surface potential ranging in magnitude from 300V to 1000V, also significantly lower than the wire voltage. However, for a tackdown application the surface potential of the receiver will need to be significantly higher than 1000V in order to generate a reasonable tackdown force. For example, when tacking down 100 μm thick paper (relative permittivity of 2) having a nominal capacitance per unit area of 18 pF/cm² onto a 100 μm thick PET web (relative permittivity of 3) having a nominal capacitance per unit area of 27 pF/cm², the total capacitance per unit area will be 10.6 pF/cm². Estimating the tackdown force using f_{tack}=0.5σ²/∈ₒ, where σ is the surface charge per unit area and ∈ₒ is the permittivity of free space, a tackdown force of roughly 0.5 PSI may be achieved by depositing 250 μC/m² on the receiver surface, resulting in a surface potential of 2.3 kV. This is difficult to achieve with a low shell voltage as a significant portion of the wire current will go to the low impedance shell rather than the high impedance receiver. This forces operation of the charger to higher current levels, necessitating wire voltages exceeding 5 kV and resulting in the arcing, charger geometry, and power consumption issues mentioned earlier. Therefore, the charging capability of this charger will be inadequate for the charging of low capacitance receivers at high speed.

A method for improving the charging efficiency of a corona charging device is described in U.S. Pat. No. 3,769,506. In this reference the charging output is enhanced by raising the potential of the shell to a voltage level of the same order of magnitude as the corona wire, either by connecting the shell to a second high voltage source or by connecting the shell to ground via a high resistance element. For example, using a shell resistance value of 10 MΩ, a shell current flow of 10 μA/in, and a corona length of 10 inches, results in a shell voltage of 1 kV, well within an order of magnitude of a corona wire voltage range of 3.5 to 8 kV. This provides greater charging and power efficiency for the device. However, this device is operated as a constant voltage charging device for rapidly and uniformly charging the surface of an insulator to a uniform surface potential, with the insulator having a ground plane underneath, as for example a photoreceptor. In a simple electrical circuit representation, the photoreceptor may be modeled as a capacitor (Cₚ) and the charging device may be represented by an ideal voltage source (V_{c}) and resistor (R_{c}). The charging time constant is given by τ_{RC}=R_{c}Cₚ. The residence time of the insulator within the charging zone is given by τᵣₑₛ=W/U where W is the width of the charging zone and U is the photoreceptor surface speed. The charging device exponentially charges up the capacitor to V_{c} and will be at 95% of V_{c} after 3 charging time constants. Typical for these applications is the desire to have τ_{RC}<τᵣₑₛ so as to operate at or near the saturation level of the charging curve, minimizing sensitivity to variations in the charging process and maximizing surface potential uniformity at a specified level. It should be noted that the surface charge density is not constant in a constant voltage charging mode. As such, a constant voltage charging mode would not work well in a tackdown application where the need is to apply a constant charge level to a static dissipative receiver transported on an insulating substrate, regardless of the capacitance of the receiver. Operation in the constant voltage mode would result in variable charge laydown, with lower capacitance receivers having lower charge levels and therefore lower tackdown forces. Although the corona wire voltage could be varied to obtain a desired charge laydown, doing so would require additional complexity and cost in order to measure the capacitance of the receiver and the charge on the member. In addition, appropriate feedback control would be required to properly adjust the voltage to maintain constant current charging. This would add cost and complexity while degrading precision and robustness.

A method for charging a photoconductive surface utilizing a shell electrode connected to a high voltage DC power supply is described in U.S. Pat. No. 4,086,650. In this reference the shell electrode is biased to either a positive or negative voltage or is grounded depending upon the surface potential desired for the photoconductive surface to be charged. When used in combination with a dielectric coated corona wire biased to a high AC voltage, the uniformity of the surface potential on the photoconductor is improved. However, although this method is suitable to charge a photoreceptor to a specified surface potential, it would not be appropriate for a tackdown application, for the same reasons as described above. In addition, the high voltage DC power supply adds cost and power consumption to the device operation.

In tri-level xerography, corona charging devices are used to alter the surface potential of a toned photoreceptor in a tri-level xerographic process as described in U.S. Pat. Nos. 4,761,668; 4,868,611; and 5,809,382. For these processes, a corona charger is used to control the surface potential of a toned photoreceptor so as to produce a favorable situation for the subsequent deposition of a second toner having a charge polarity opposite to that of the toner previously deposited on the photoreceptor. The mode of operation for this charging device is to uniformly adjust the surface of the insulating photoreceptor to a desired constant potential. Therefore, this device would suffer the same limitations as discussed previously when used for applications requiring deposition of constant surface charge onto a static dissipative object on a moving insulating web.

There is a continuing need, therefore, for an improved method of charging with constant current a static dissipative member on a moving insulating web.

### SUMMARY OF THE INVENTION

Briefly, according to one aspect of the present invention a method for charging a static dissipative object on an insulating surface with a constant current includes placing a corona electrode in close proximity to the static dissipative object; placing a shell electrode in close proximity to the corona electrode; connecting a high voltage power supply to the corona electrode; raising the potential of the shell electrode to at least one tenth the magnitude of the potential of the corona electrode; sensing a first current from the high voltage power supply to the corona electrode; sensing a second current from the shell electrode to ground; and adjusting a voltage on the high voltage power supply to maintain a constant difference between the first current and the second current.

An advantage of this invention is that it provides an electrostatic tackdown force to lower capacitance receivers, greatly extending the range of transportable receivers to thicker, lower dielectric, higher resistivity materials. Another advantage is this extended capability in charger output and efficiency may be achieved in a low cost manner with reduced power consumption. The invention and its objects and advantages will become more apparent in the detailed description of the preferred embodiment presented below.

### BRIEF DESCRIPTION OF THE DRAWINGS

FIG. 1 is an electrical schematic diagram for a constant current corona charging device as described in prior art.

FIG. 2 is a schematic diagram of a tackdown system for electrostatically tacking a receiver to a moving, insulating transport web.

FIG. 3 provides a chart of experimental data demonstrating the improved charging efficiency of the invention.

FIG. 4 provides a chart of experimental data demonstrating the higher ratio of shell to wire voltage (Vₛₕₑₗₗ/V_{wire}) of the invention.

FIG. 5 provides a chart of experimental data demonstrating the enhanced capability for charging low capacitance receivers with this invention.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

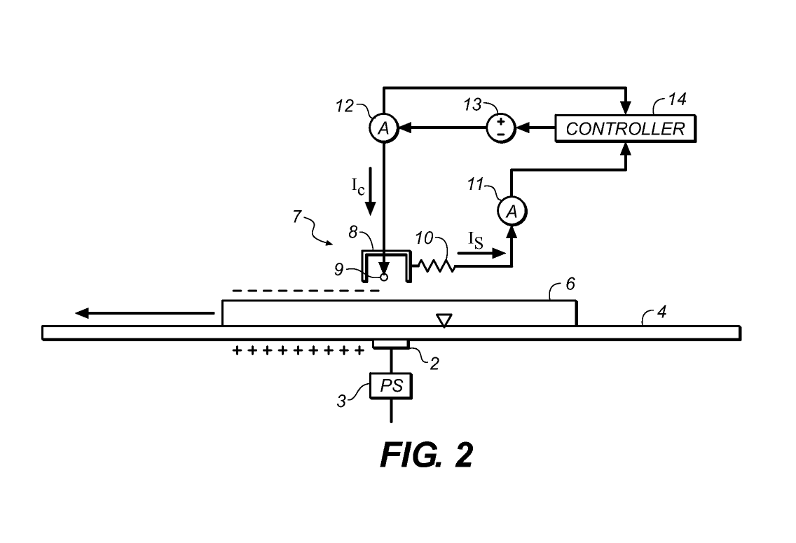

Referring now to FIG. 2, a schematic diagram is shown for a tackdown system for electrostatically tacking a receiver to a moving, insulating transport web. Receiver 6 is fed onto moving transport web 4 using a paper feed system (not shown). Corona charging device 7 consists of a corona electrode 9 and conductive shell 8. Corona electrode 9 is an electrical conductor connected via ammeter 12 to power supply 13 and raised to a high voltage. Ammeter 12 measures corona current I_{c} output by corona electrode 9. Corona electrode 9 is formed in a shape that creates an electric field that exceeds the breakdown strength of air either in the immediate vicinity of the electrode or at the electrode surface. For example, this shape may be a small diameter wire (less than or equal to 1 mm) or an array of pins or a set of bristles or fibers. Conductive shell 8 is connected through resistor 10 to ground via ammeter 11. Ammeter 11 measures current Iₛ collected by conductive shell 8 and is at a potential within a few volts of ground potential. The current of ammeter 11 is fed into controller 14. Controller 14 is used to monitor the difference in current measured by ammeters 12 and 11 and maintain a desired difference between I_{c} and Iₛ, by adjusting the output of power supply 13, resulting in a constant current flow to receiver 6. Alternatively, power supply 13 has the capability of sensing the current I_{c} supplied to corona electrode 9, sensing the current Iₛ collected by shell 8 and returned through resistor 10, and the capability of adjusting the voltage on corona electrode 9 so as to regulate and maintain a desired difference in current between I_{c} and Iₛ, resulting in a constant current flow to receiver 6. An example of a high voltage power supply having this capability is a Trek Cor-A-Trol Model 610C. Counter electrode 2 is located opposite corona charging device 7, contacts transport web 4, and is maintained at a constant potential via power supply 3. This potential may be ground or some other non-zero potential. Conductive electrode 2 may be flat plate or shoe as shown in FIG. 2 or may be a roller, conductive belt, or a conductive layer on the underside of transport web 4.

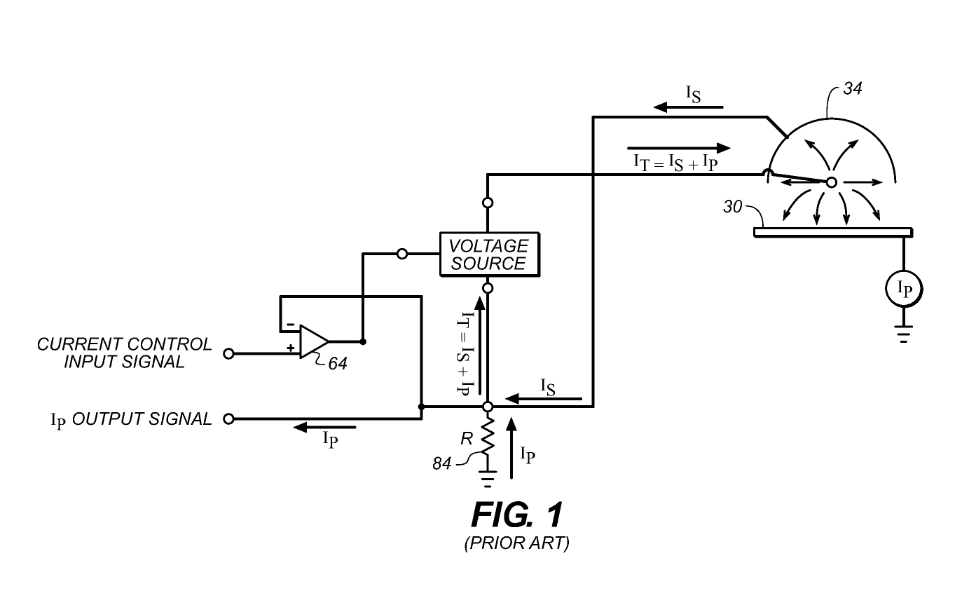

When receiver 6 passes under corona charging device 7 a constant charge per unit area is deposited on its surface. For example, in FIG. 1 the corona electrode 9 is raised to a high voltage of negative polarity so the receiver surface is negatively charged. As the receiver exits the corona device a charge of opposite polarity is deposited on the lower surface of transport web 4, in this case the surface is positively charged.

Receiver 6 is typically a static dissipative material such as fiber based paper but may also include synthetic components at various blend ratios or may be a completely plastic material such as polyester terephthalate (PET) or may be a composite material such as a peelable label having an adhesive component or have a magnetic component such as printable magnets.

Transport web 4 is comprised of an insulating material having a thickness and modulus sufficient so as to support a web tension necessary for conveyance of receiver 6 through the electrophotographic printer while retaining its dimensional integrity. Examples of such a material include, but are not limited to, polyethylene terephthalate (PET), polyamide, polyimide, and polycarbonate. These materials may have a conductive or static dissipative layer on the side of the web contacting counter electrode 2. One example of such a web is a 100 μm thick PET web having a modulus ≧1 GPa. Resistor 10 is greater than 1 MΩ in value and preferably in the range of 5 MΩ to 20 MΩ.

In another embodiment, conductive shell 8 is connected to a high-voltage power supply and raised to a voltage of at least one tenth that of the corona electrode voltage so as to improve the charging output of corona charging device 7. Power supply 13 may be of a DC excitation, pulsed DC excitation, or AC excitation.

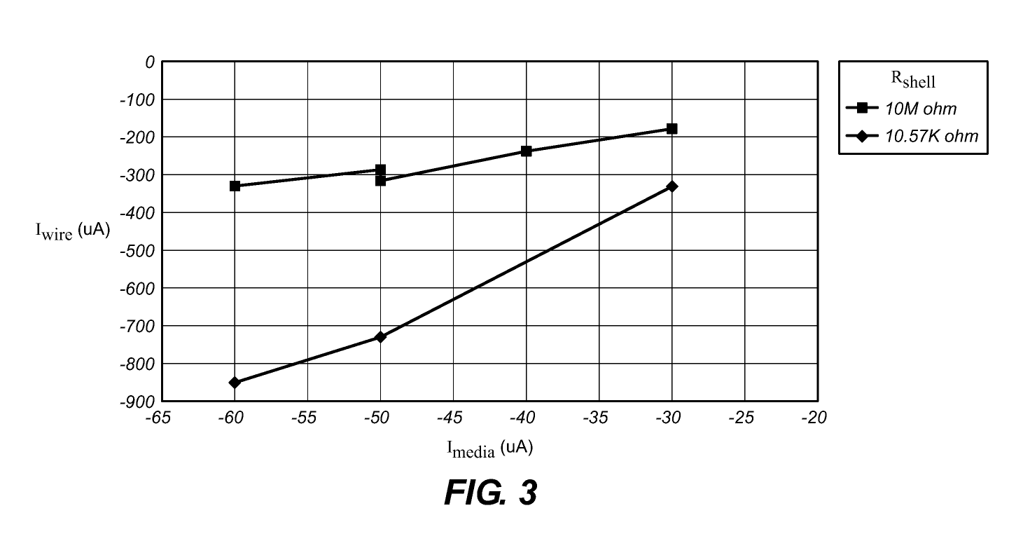

The embodiment shown in FIG. 2 was utilized to provide experimental data demonstrating the benefit of one embodiment of the invention. As part of the printing process, a NexPress 2100 press performs the step of charging a receiver so as to electrostatically tack it onto a moving, insulating PET transport web, as shown in FIG. 2. Two different shell resistance values (Rₛₕₑₗₗ) were used for resistor 10, 10.57 KΩ or 10 MΩ. A low capacitance paper receiver having a thickness of 350 μm was tacked to the 100 μm PET web using current levels (I_{media} on the horizontal axis) ranging from −30 μA to −60 μA. The transport web speed was 0.514 mm/sec. The corona wire current (I_{wire} on the vertical axis) required to deliver the desired media current is shown by the two curves in FIG. 3, one for Rₛₕₑₗₗ equal to 10.57 KΩ (diamond symbol) and the other for Rₛₕₑₗₗ equal to 10 MΩ (square symbol). As readily observed in FIG. 3, much less I_{wire} is required to deliver the desired I_{media} when using a 10 MΩ resistor, demonstrating the large increase in charging efficiency with increasing Rₛₕₑₗₗ.

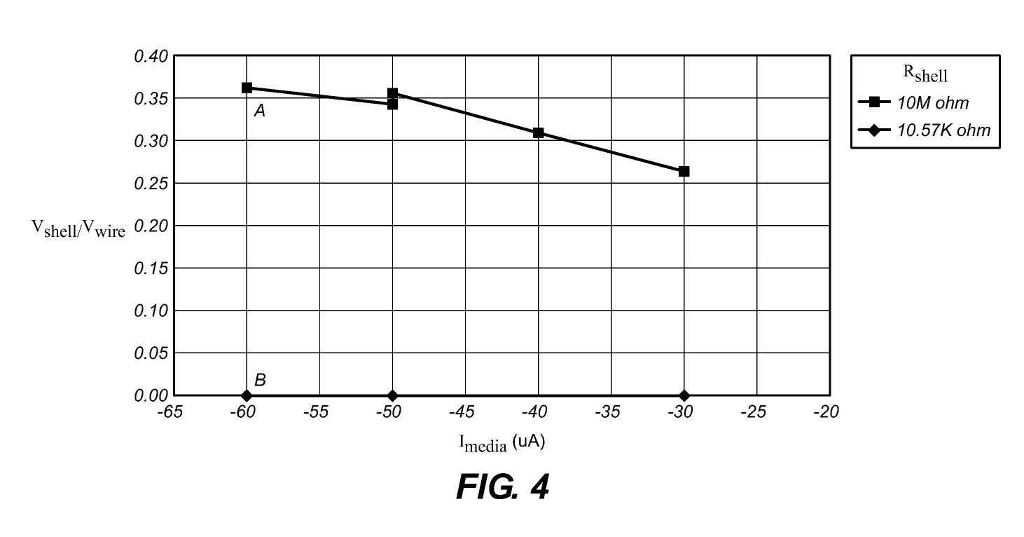

Shown in FIG. 4 is accompanying data to that of FIG. 3, providing the ratio of shell voltage to wire voltage (Vₛₕₑₗₗ/V_{wire} on the vertical axis) as a function of the media current (I_{media} on the horizontal axis) for the two different resistance values of Rₛₕₑₗₗ. It is observed that the increase in charging efficiency using an Rₛₕₑₗₗ of 10 MΩ is accompanied by a Vₛₕₑₗₗ/V_{wire} ratio in excess of 0.1 under these circumstances.

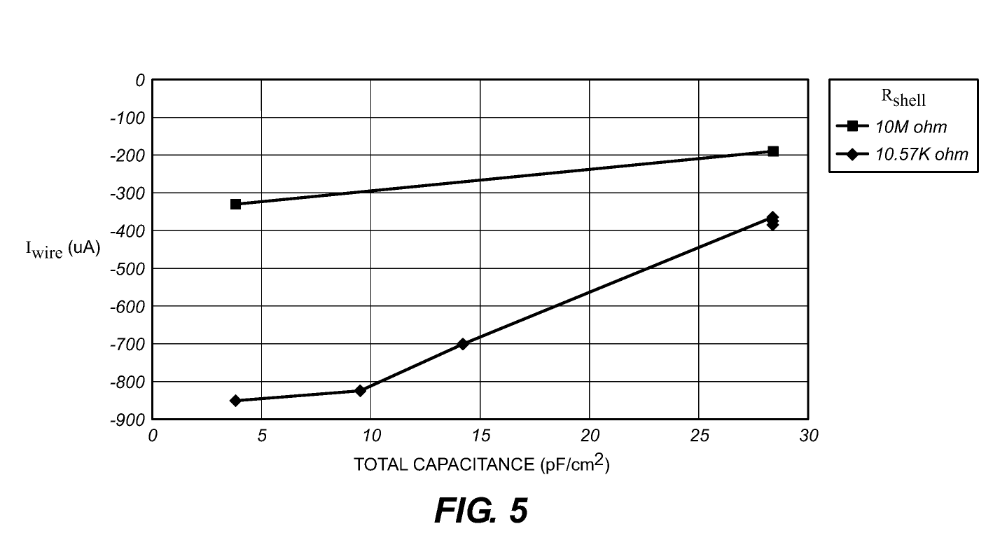

Shown in FIG. 5 is the beneficial aspect of the invention with respect to charging a low capacitance receiver. As described earlier, the total capacitance to be charged, receiver on transport web, is given by c_{rtw}=[1/cᵣ+1/c_{tw}]⁻¹. For this case, the transport web has a capacitance (c_{tw}) of 28.3 pF/cm². A variety of receivers were tested, having a receiver capacitance cᵣ ranging from 4.3 to 28.3 pF/cm², resulting in a total capacitance c_{rtw} ranging from 3.7 to 14.2 pF/cm². In addition, the charging performance was characterized with no receiver on the transport web, resulting in a total capacitance c_{rtw} of 28.3 pF/cm². The operational media current (I_{media}) was −60 μA and the transport web speed was 0.514 mm/sec. The charging efficiency is greatly improved for low capacitance receivers when using an Rₛₕₑₗₗ of 10 MΩ (square symbols) as compared to 10.57 KΩ, evidenced by the greatly reduced wire currents (I_{wire}) required to deliver −60 μA to the receiver.

The invention has been described in detail with particular reference to certain preferred embodiments thereof, but it will be understood that variations and modifications can be effected within the scope of the invention.

### PARTS LIST

2 counter electrode
3 power supply
4 transport web
6 receiver
7 corona charging device
8 conductive shell
9 corona electrode
10 resistor
11 ammeter
12 ammeter
13 power supply
14 controller
34 shell
64 amplifier
84 resistor

1. A method for charging a static dissipative object on an insulating surface with a constant current comprising:
placing a corona electrode in close proximity to the static dissipative object;
placing a shell electrode in close proximity to the corona electrode;
connecting a high voltage power supply to the corona electrode;
raising the potential of the shell electrode to at least one tenth the magnitude of the potential of the corona electrode;
sensing a first current from the high voltage power supply to the corona electrode;
sensing a second current from the shell electrode to ground; and
adjusting a voltage on the high voltage power supply to maintain a constant difference between the first current and the second current.

2. The method of claim 1 wherein the shell is connected to ground through a resistor.

3. The method of claim 2 wherein the resistor is greater than 1 MΩ.

4. The method of claim 2 wherein the resistor is in the range of 5 MΩ to 20 MΩ.

5. The method of claim 1 wherein the shell is connected to a high-voltage power supply.

6. The method of claim 1 wherein the corona electrode is selected from a group consisting of corona wire, pin electrodes, or brush electrode.

7. The method of claim 1 wherein the high voltage power supply is selected from a group consisting of a DC, pulsed DC, or AC excitation.
